(19) United States
(12) Patent Application Publication
(10) Pub. No.: US 2013/0040471 A1
(43) Pub. Date: Feb. 14, 2013

(54) INTERPOSER FOR COBRA HEAD STREETLIGHT

(71) Applicants: WILLIAM J. GERVAIS, NORTHRIDGE, CA (US); MARK H. HELMICK, VENTURA, CA (US)

(72) Inventors: WILLIAM J. GERVAIS, NORTHRIDGE, CA (US); MARK H. HELMICK, VENTURA, CA (US)

(73) Assignee: QUALSTAR CORPORATION, SIMI VALLEY, CA (US)

(21) Appl. No.: 13/569,040

(22) Filed: Aug. 7, 2012

Related U.S. Application Data
(60) Provisional application No. 61/521,199, filed on Aug. 8, 2011.

(51) Int. Cl. H01R 12/70

(52) U.S. Cl. 439/56

(57) ABSTRACT

An interposer adapted to interrupt the power source of a streetlight and intervening between an existing photo-controller and the streetlight with a lamp connected to a power line, the interposer having a body having a top and a bottom, the top of the body having an electrical receptacle, the bottom of the body having an electrical plug, the body containing a microprocessor and a load switch connected to the main power line and lamp, wherein the microprocessor instructs the load switch to selectively connect and disconnect the power line and the lamp, or to dim a multi-level lighting device.

### CROSS-REFERENCE TO RELATED APPLICATION

This application claims priority from U.S. Provisional patent application No. 61/521,199, filed Aug. 8, 2011, which contents are hereby incorporated by reference in their entirety.

### FIELD OF THE INVENTION

The present invention is directed to an interposer for a cobra head type street lamp.

### BACKGROUND

Current day cobra head street lights, installed in the 1960s and proliferating in the 70′s and 80′s use sodium vapor, mercury vapor, or metal halide lamps. A small street light fixture consumes energy at the rate of 175 watts, a medium fixture at the rate of 200-400 watts, and a large fixture at the rate of 1000 watts. It is thus easy to see that many light fixtures can tax the energy resources of a power station or a city's power grid, yet reducing the number of streetlights or each lamp's lumens output may endanger drivers on the road at night or may promote criminal activity in a darkened area.

Hence there have been efforts to improve the energy consumption of streetlights. Many streetlights were manufactured or retrofitted with photoelectric street light controllers, which turn on a streetlight when an insufficient amount of light falls on a photo-detector. The result is the light coming on at dusk and off at dawn. Yet even with the photo-detector control, the illumination is not needed during some hours of the on time, leading to wasted electricity and reducing the life of the lighting equipment. This leads to unnecessary operating and maintenance costs.

The photo-controllers are connected to the light fixtures using a standardized electrical connector, which provides both electrical connections and mechanical mounting. An example of a photoelectric lighting control unit adapted to street light use is U.S. Pat. No. 2,709,224 (Garnick). To further control electricity consumption of streetlights, timers can be used in combination with photo-detector controllers, as in, for example, U.S. Pat. No. 4,731,551 (Gibbs et al.).

### SUMMARY OF THE INVENTION

The present invention interposer in a preferred embodiment mounts between the light fixture and a photoelectric controller. The preferred embodiment is equipped with a male connector which mates to the light fixture, and a female connector at the opposing end which mates with the photoelectric controller. The interposer monitors the output of the photoelectric controller, and interrupts and/or throttles back the power supplied to the lamp according to an algorithm, thus reducing the amount of time the lamp is unnecessarily energized, dims the lamp to reduce energy consumption, or both. The algorithm is implemented in the present invention interposer using a micro-controller, microprocessor, or other programmable device.

As such, the present invention smart controller in interposer form can be used to further retrofit present day street lamps, or cobra head streetlights, that already have a “dumb” photo-detector controller. The present invention smart controller/interposer efficiently, economically, and easily improves the electricity demand of the street lamp. If the interposer is used in sufficient numbers, the reduction in electricity consumption from the streetlights on the power grid for a city or local municipality is significant. In view of ever-rising cost of energy and the tightening budgets of governments and businesses in the private sector, such cost saving measures for energy are vital to avoiding financial crises.

Aside from the economic benefit, minimizing wasted energy directed to lighting helps the power grid re-channel power to crucial areas, especially during peak power consumption periods during the evening. This then minimizes brown outs or rolling black outs where demand for electricity outstrips supply.

### BRIEF DESCRIPTION OF THE DRAWINGS

FIG. 1 is an exploded view of the present invention interposer inserted between the existing photo-controller and the cobra head streetlight.

FIGS. 2(a)-2(f) are multiple views of a preferred embodiment interposer.

FIG. 3 is a simplified electrical schematic of a preferred embodiment of the present invention interposer.

### DETAILED DESCRIPTION OF THE PREFERRED EMBODIMENTS

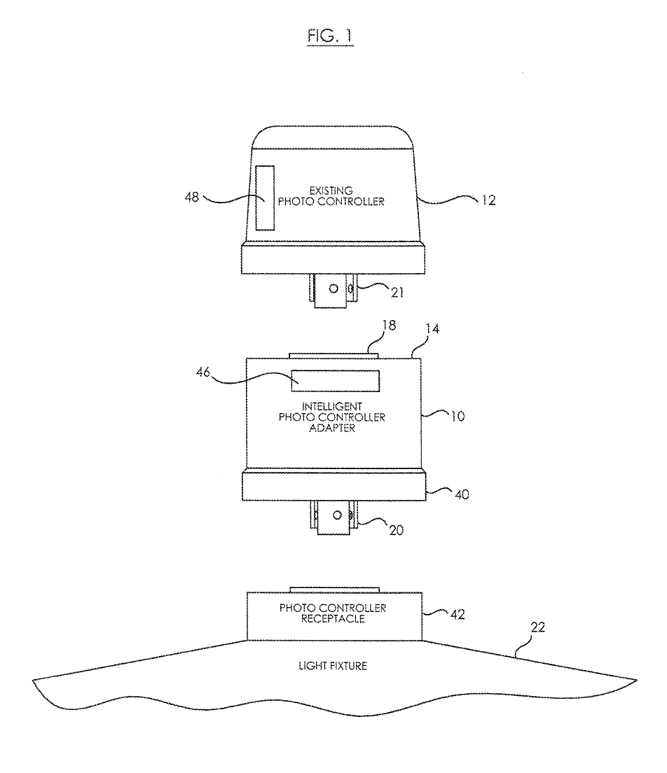

The present invention is directed to an interposer. FIG. 1 is an exploded side elevation view of a modular interposer 10 that is preferably installed between a standard, pre-existing photo-controller 12 and a common cobra head streetlight 22. The photo-controller 12 has a window 48, and behind the window is the photocell 34 used for detection of sunrise and sunset. Only the top of the cobra head streetlight 22 is shown. The present invention interposer 10 can be adapted for use with any standard outdoor light fixture, lamp, security light, etc., and not necessarily limited to streetlights or cobra head streetlights.

As seen in FIG. 1, the standard cobra head streetlight 22 has been fitted with a receptacle 42 to accept the electrical connector/plug 20 of the photo-controller 12 so that the on/off times of the streetlight 22 can be controlled for the individual lamp based on dawn or dusk (i.e., sunrise/sunset) lighting conditions. The interposer 10 when installed as shown in FIG. 1 dramatically enhances control of the streetlight 22 beyond the photo-controller 12. Specifically, the streetlight 22 is easily retrofitted by inserting the interposer 10 in between the streetlight 22 and the photo-controller 12. The interposer 10 has an electrical connector 18 that is identical to the electrical connector 21 of the photo-controller 12, so the interposer 10 takes the place of the photo-controller 12 directly above the streetlight 22, and the photo-controller 12 then stacks on top of the interposer 10. The electrical connector 20 of the interposer 10 is arranged so that when the two are stacked together, the compass alignment of the photo-controller 12 is not disturbed by the interposer, and the photocell window 48 faces in the direction for sunrise/sunset detection. With the interposer 12 in place, there is improved control on lamp behavior, which ultimately leads to reduced electrical consumption and translates to significant cost savings for the utility, power company, city, municipality, homeowner's association, etc. that typically provide and pay for roadside or sidewalk lighting.

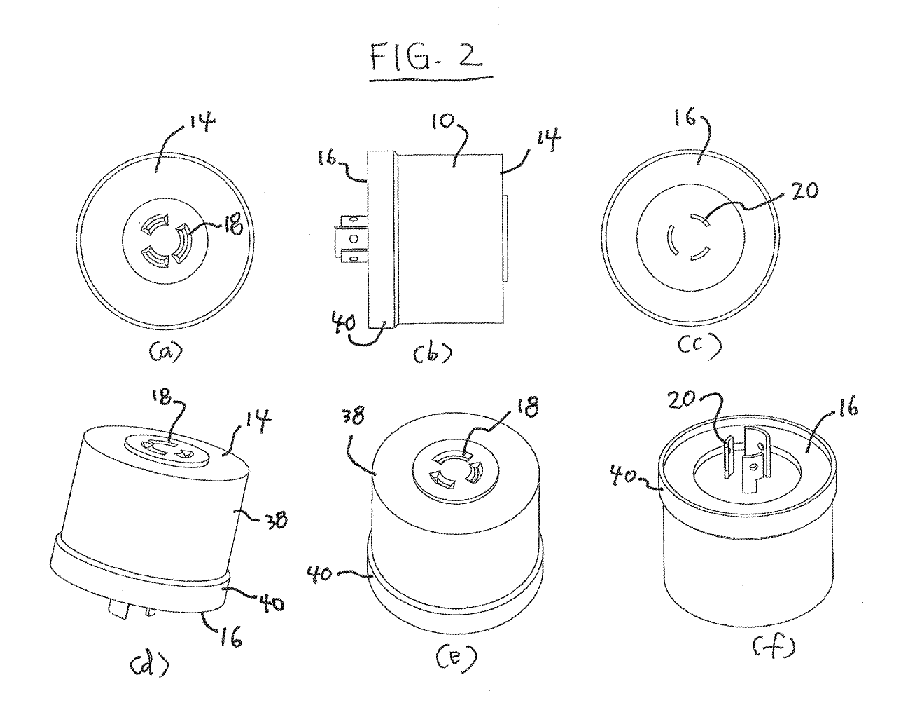

FIGS. 2(a)-2(f) are various views of the preferred embodiment interposer 10. The interposer 10 has a top surface 14 and a bottom surface 16. The top surface 14 includes a receptacle 18. In this embodiment, the receptacle 18 is designed to receive a three-prong, AC power plug that is found on most photo-controllers 12.

The interposer 10 preferably has a cylindrical body 38 to match the standard cylindrical shape of the photo-controller 12 and the shape of the socket of the streetlight 22. The bottom of the body 38 includes an optional lip 40 that helps cover the electrical connection at the socket to block out rain or snow, and protects that connection from dust build up and insect infestation.

As seen in FIGS. 2(c) and 2(f), at the bottom surface 16 is a three-prong plug 20 electrical connector identical to the three-prong plug of the photo-controller 12. The three prongs are used for AC power with one for the power source, one for the load, and one for the common. Each prong, pin or blade of the three prong plug 20 is curved, as seen in FIG. 2(c), with a “flag” shape profile, as seen in FIG. 2(f). The curved shape and “flag” profile enable the interposer 10 to be inserted underneath the photo-controller 12 so that the interposer 10 can lock to the socket at the top of the streetlight 22, which previously received the photo-controller 12. The locking action is accomplished by pushing the plug into the socket and twisting clockwise. Reversing the action detaches the interposer 10 from the streetlight 22. The photo-controller 12 mounts to the top of the interposer 10 by the same mechanism.

Accordingly, with easy twist-and-lock modular design, the present invention can be quickly installed in a large number of cobra head streetlights 22. It is a simple matter to twist and unlock the pre-existing photo-controller 12, insert the interposer 10 and lock it to the streetlight 22, then re-install the photo-controller 12 on top of the interposer 10. This arrangement is shown in FIG. 1.

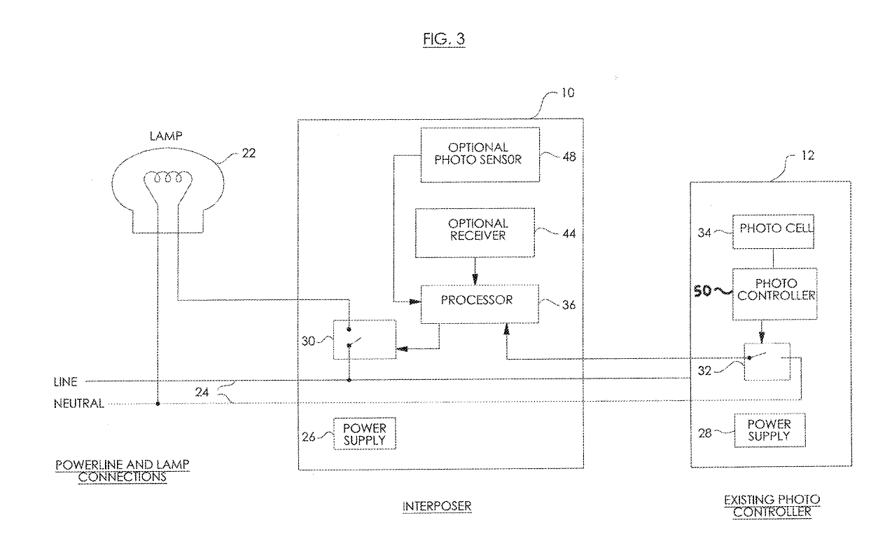

The present invention interposer 10 in a preferred embodiment is self-contained within a single cylindrical body 38 as seen in FIG. 2. FIG. 3 is a simplified electrical schematic of a preferred embodiment of electrical components contained inside the body 38. Streetlight 22 has a lamp that is energized via AC power line 24. The AC power line 24 carries the major load/current needed to run the sodium vapor, mercury vapor, metal halide, LED, fluorescent, CFL, or similar type lamp. The interposer 10 and photo-controller 12 may have their respective own power supplies 26, 28, respectively, to operate the relays or solid state switches 30, 32 that open and close the AC power line circuit to switch the lamp off and on.

The interposer 10 is directly wired to the major load/AC power line 24, without need for redirecting power via an auxiliary load. The interposer 10 thus interrupts power in the main load/AC power line 24, without complications of requiring the auxiliary load, redundant electronics, timers, inherent line loss, and the like from the auxiliary load.

Inside the photo-controller 12 behind the window 48 is a photocell 34 that operates the switch 32 based on amount of ambient light detected by the photocell 34. For example, once the ambient light detected by the photocell 34 falls below a predetermined threshold, the switch 32 is closed and line power is directed to the lamp. However, in the embodiment shown in FIG. 3, the “dumb,” light activated on/off switch 34 is enhanced by the present invention interposer 10 that uses a digital microprocessor 36 to make a further determination as to when the lamp should be turned on or off.

The low voltage power supply 26 can be used to power the microprocessor 36. The power supply 26 may be a linear power supply, a switching type power supply, a capacitor divider power supply, or a shunt power supply drawing current directly from the main line 24, or the like. A switching power supply is preferably and potentially the most efficient, while a capacitor divider or shunt power supply offer the least cost. Additional capacitor storage can be used to keep the digital microprocessor running during short power outages.

The digital micro-controller or microprocessor 36 may be programmed at the factory to activate and deactivate the lamp based on information kept in the memory in addition to mere ambient lighting conditions. Such information may include sunrise/sunset times for the geographic region and for that season, the Global Positioning Satellite (GPS) location of the interposer, phases of the moon that affect how dark the night is, power consumption patterns of the local area's power grid, etc. Based on such information, the microprocessor 36 controls the switch 30 to interrupt and override the on/off actions of the photo-controller 12, throttle back on power delivered to the lamp to dim the lamp, or both. Many microprocessors are offered that could be used in this function, including offerings from Microchip, Atmel, Zilog, Freescale and others.

To advance the intelligence of the street light on/off control, the algorithm for the microprocessor 36 can be programmed to:

(a) Synchronize to the day/night cycle to allow prediction of when the sunrise will occur.

(b) Delay turning on the lamp for a fixed time after the photo-controller would have turned it on, which would minimize erroneous triggering events such as a cloud blocking the photocell or errant light reflections on the photocell.

(c) Allow the lamp to operate for a fixed time, after dusk occurs, which would be useful in more remote, less populated areas where the lamp can be turned off several hours after dusk to save electricity and to minimize light pollution when evening traffic subsides.

(d) Allow the lamp to operate for a fixed percentage of the night, after dusk occurs. This would be advantageous when, for example, it is desired that the streetlight remain on until midnight. The device would measure the length of the day and night times, and could therefore leave the light on for half of the period of darkness.

(e) Allow the lamp to operate for a fixed time before dawn occurs. This would be advantageous in instances when traffic is heavy for some period before dawn, such as workers who need to be at their work location at dawn, and therefore are commuting in the darkness before dawn.

(f) Allow the lamp to operate for a fixed percentage of the night, before dawn occurs. This would be advantageous in instances when, for example, it is desired to have the streetlights on from midnight until dawn.

(g) Turn off the lamp a fixed time before dawn. This would be advantageous in situation of prolonged twilight; such as in extreme latitudes, when one wants to conserve power by turning off the lamps before the photo-controller would.

(h) If the photo-controller 12 powers up and immediately wants to turn on the lamp, the microprocessor waits a random delay (up to several seconds), so all the lights on one circuit in a geographic local of the power grid do not try to start at the same time, which might drag down the line and cause further problems. This feature is advantageous if the city's streetlights were on a timer, if the power grid were recovering from a power failure, or if the circuit was just turned-on due to servicing.

As described above, the interposer 10 has a microprocessor 36 that preferably includes non-volatile memory storage. Thus, the above-noted control parameters and operating feature options may be saved and recalled as needed. The microprocessor may include a digital serial communications interface for setting parameters and operating feature options. Such a feature allows streetlights to be optionally reprogrammed in the field to tailor the behavior, in addition to the factors described above, to urban versus rural lighting conditions, population density, traffic, criminal activity, etc. Additionally, the operating hours could be different or varied depending on the day of the week, workday versus weekend, etc.

The interposer 10 in alternative embodiments may utilize a wireless radio frequency (RF) or infrared digital receiver to allow adjustment of parameters and select operating features using a portable infrared transmitter remotely from the ground. Thus, the behavior or control parameters of the interposer 10 can be altered without requiring a technician to climb to the top of a light pole to make adjustments or to replace the interposer. Also, the function of the lamp can be checked from the ground by remotely turning on the lamp in the daytime without the need to ascend the light pole.

In this embodiment, the interposer 10 is preferably modified by adding a wireless RF or infrared receiver 44 as seen in FIG. 1, and optionally a RF or infrared transmitter (not shown). The infrared receiver 44 is preferably facing toward the ground where the technician is standing. An optional lens 46 filters out wavelengths of electromagnetic radiation outside of desired range to minimize errant signals from accidentally reaching the receiver 44. The technician on the ground controls the RF or infrared transmitter, which transmits data sequences to the receiver 44 on the interposer 10 to alter the behavior or the interposer, or to perform on/off/dim lamp tests, etc.

The interposer 10 in another alternative embodiment employs a TRIAC, SCR or other solid state dimmer circuit in place of switch 30 to allow dimming when using a dimmable lamp, especially favorable for a dimmable LED lamp. To be sure, the trend is to replace obsolete sodium vapor, mercury vapor, or metal halide streetlights that are typically not dimmable with more power efficient LED lamps. This dimming feature would provide the ability to reduce the lamp intensity to different levels and save electricity during periods when less light is needed, such as in the middle of the night without turning the lamp off completely. In other words, it would possible via the interposer to have more than one brightness level programmed in, so when less light is required, the device could reduce power to save electrical power.

Furthermore, the interposer 10 may itself utilize an optional, secondary photo-detector or sensor 50 that can differentiate between the streetlight 22 being in the shadow of a tree or building, and actual twilight conditions when the lamp would be properly illuminated. The photo sensor 50 could be a photodiode, and phototransistor or a photo resistive device. By measuring the actual light levels with respect to time, instead of comparing the light level to a fixed value, the interposer 10 can determine sunrise and sunset more accurately if the interposer were in the shadow during parts of the day. The interposer 10 then discriminates between actual day and night cycles, and periods of shadow by synchronizing an internal software clock to the day and night cycle.

The microprocessor 36 may be programmed to shut off the lamp if a brownout condition is detected. The brownout condition can be detected by the microprocessor when there is a drop in line voltage. This is to protect the lamp from improper voltage spikes or drops, and to ease the brown out condition for the city or municipality's power grid. Further, the device could delay a random amount after the power returns to normal, so all the lamps on a circuit do not try to start up at the same time avoiding sudden loads on the power grid.

While particular forms of the invention have been illustrated and described, it will be apparent that various modifications can be made without departing from the spirit and scope of the invention. Features and components from one embodiment may be combined with another embodiment. Accordingly, it is not intended that the invention be limited except as by the appended claims.

We claim:

1. A interposer adapted to interrupt the power source of a street lamp and intervening between an existing photo-controller and the street lamp with a lamp connected to a power line, the interposer comprising:
a modular body having a top and a bottom;
the top of the body having an electrical receptacle to receive a connector of the existing photo-controller therein;
the bottom of the body having an electrical connector to plug into the street lamp;
the body containing a microprocessor and a main load switch connected to the power line and lamp, wherein the microprocessor instructs the main load switch to selectively connect and disconnect the power line and the lamp;
the microprocessor having timing firmware wherein the microprocessor is programmed to at least one of:
synchronize to the day/night cycle to allow prediction of when sunrise will occur;
delay turning on the lamp for a fixed time after the photo-controller would have turned the lamp on;
allow the lamp to operate for a fixed time after sunset occurs;
allow the lamp to operate for a fixed percentage of the of the night after sunset occurs;
allow the lamp to operate for a fixed time before sunrise occurs;
allow the lamp to operate for a fixed percentage of the night before sunrise occurs; and
turn off the lamp a fixed time before sunrise.

2. The interposer of claim 1, wherein the interposer includes an infrared data receiver which connects to the microprocessor, and wherein a portable, remote infrared transmitter programs the interposer with operating parameters, and enables remote control of the lamp.

3. The interposer of claim 1, wherein the interposer includes a serial communications link that connects to the microprocessor, and wherein a remote computer linked to the interposer programs the interposer with operating parameters when the interposer is at least one of manufactured, configured for installation, and serviced.

5. An interposer adapted to interrupt the power source of a street lamp and intervening between an existing photo-controller and the street lamp with a lamp connected to a power line, the interposer comprising:
a modular body having a top and a bottom;
the top of the body having an electrical receptacle to receive a three-blade connector of the existing photo-controller;
the bottom of the body having a three-blade electrical connector with a twist lock connecting to the street lamp;
the body containing a circuit having digital microprocessor and a main load switch connected to the power line and lamp, wherein the microprocessor instructs the main load switch to selectively connect and disconnect the power line and the lamp;
the circuit including a triac dimming circuit controlled by the microprocessor to reduce current to the lamp to dim the lamp;
the microprocessor having stored sunrise/sunset times and timing firmware, wherein the microprocessor is selectively programmed to:
delay turning on the lamp for a fixed time after the photo-controller would have turned the lamp on;
allow the lamp to operate for a fixed time after sunset occurs;
allow the lamp to operate for a fixed percentage of the of the night after sunset occurs;
allow the lamp to operate for a fixed time before sunrise occurs;
allow the lamp to operate for a fixed percentage of the night before sunrise occurs; and
turn off the lamp a fixed time before sunrise.

6. The interposer of claim 5, wherein the lamp is comprised of light emitting diodes.

7. The interposer of claim 5, wherein the body includes an infrared detector disposed at an exterior of the body, the infrared detector receiving a remote transmission signal that is passed to the microprocessor.

8. The interposer of claim 7, wherein the infrared detector includes a lens facing toward the bottom of the body toward the street, and the lens includes a band pass optical filter to transmit radiation in the infrared spectrum.

9. The interposer of claim 7, wherein the circuit is wired directly to the power line and does not require an auxiliary load or power.

10. An interposer adapted to interrupt the power source of a street lamp and intervening between an existing photo-controller and the street lamp with a lamp connected to a power line, the interposer comprising:
a modular body having a top and a bottom;
the top of the body having an electrical receptacle to receive a connector of the existing photo-controller therein;
the bottom of the body having an electrical connector to connect to the street lamp;
the body containing a circuit having digital microprocessor and a main load switch connected to the power line and lamp, wherein the microprocessor instructs the main load switch to selectively connect and disconnect the power line and the lamp;
a means for receiving a wireless transmission, which means for receiving outputs a signal to control the microprocessor based on the wireless transmission;
the microprocessor having data storage of sunrise/sunset times and timing firmware, wherein the microprocessor is selectively programmed to:
synchronize to the day/night cycle to allow prediction of when sunrise will occur based on the sunrise/sunset times;
delay turning on the lamp for a fixed time after the photo-controller would have turned the lamp on;
allow the lamp to operate for a fixed time after sunset occurs;
allow the lamp to operate for a fixed percentage of the of the night after sunset occurs;
allow the lamp to operate for a fixed time before sunrise occurs;
allow the lamp to operate for a fixed percentage of the night before sunrise occurs; and
turn off the lamp a fixed time before sunrise.

11. The interposer of claim 10, wherein the circuit includes a triac dimming circuit controlled by the microprocessor to reduce current to the lamp to dim the lamp.

12. The interposer of claim 10, wherein the means for receiving the wireless signal includes at least one of an infrared detector and an RF receiver.

13. The interposer of claim 10, wherein the output signal from the means for receiving the wireless transmission via the microprocessor turns on and turns off the lamp.

14. The interposer of claim 10, wherein the modular body at the bottom plugs into the street lamp and receives the existing photo-controller at the top, and the modular body when installed maintains a compass alignment of the existing photo-detector to preserve sunrise/sunset detection.

15. The interposer of claim 10, wherein the interposer includes a secondary photo-controller.
